(19) United States
(12) Patent Application Publication
(10) Pub. No.: US 2016/0189102 A1
(43) Pub. Date: Jun. 30, 2016

(54) A CARGO SHIPMENT ROUTE DETERMINATION APPARATUS AND METHOD

(71) Applicant: Tradeos Limited, Jerusalem (IL)

(72) Inventor: Zvi SCHREIBER, Jerusalem (IL)

(73) Assignee: Tradeos Limited, Kowlon (HK)

(21) Appl. No.: 14/909,746

(22) PCT Filed: Mar. 10, 2014
(86) PCT No.: PCT/IL2014/050239

§ 371 Date: Feb. 3, 2016

Related U.S. Application Data
(60) Provisional application No. 61/863,100, filed on Aug. 7, 2013.

(51) Int. Cl. G06Q 10/08

(52) U.S. Cl. CPC G06Q 10/08355

(57) ABSTRACT

A method comprising: providing data regarding a plurality of shipment services, each datum comprising a service origin and destination pair and price information; providing data regarding a plurality of shipment service providers, each shipment service associated with a shipment service provider; providing a shipment origin and destination of the cargo; responsive to the shipment origin, the shipment destination and a predetermined route viability criterion, identifying a viability set of the shipment services; responsive to a predetermined business relationship criterion, identifying a set of the shipment service providers; responsive to the identified shipment service viability set and the identified provider set, determining, in real-time, a shipment route for the cargo from the provided shipment origin to the provided shipment destination; responsive to the shipment service price information, determining, in real-time, price information associated with the determined shipment route; and outputting the determined shipment route and the determined associated price information.

### TECHNICAL FIELD

The invention relates generally to the field of route determination, and in particular to a cargo shipment route determination apparatus and method.

### BACKGROUND

For many businesses it is necessary to frequently choose a route or routes for a shipment of freight (cargo) between two points on the planet, often in different countries. A typical route would involve multiple legs such as: a trucking service from the shipment origin address to a port; one or more airplane and/or ocean freight transportation services; and a trucking service from a second port to a shipment destination address.

It will be appreciated that each of these three or more “legs” of the route may be sourced from different transportation vendors, and therefore planning and pricing of each leg will require different data sources, e.g. from a trucking company in the origin country, from an airline or ocean carrier, and from a trucking company in the destination country. Typically, such route planning and pricing is done manually by company employees. This consumes a great amount of time and doesn't allow for optimal route selection as the employee will not have all of the options before him or her. Additionally, after requesting price quotes from different service providers, the company may have to wait several days before collecting all the data required for the overall quote.

One algorithm for automated shipment route determination would involve checking all shipment route combinations. For example, in considering a door to door shipment of freight from London, England, to Chicago, Ill., a database of trucking services would be queried for services from a shipment origin address in London to any port. Second, it would be necessary to loop through all of those services, and for each of those, query another database for all available air/ocean services from that port to a port in the US (and perhaps also in other countries which might provide good connecting flights between the UK and US). Third, it would be necessary to loop through all of those combined truck and air/ocean services from the shipment origin address in London to a port in the US, and for each such combination query a third database for trucking services from the port to the final destination in Chicago.

It is appreciated that such nested loops can be extremely time consuming, and even more so when considering four and five leg routes via connecting ports. Additionally, such an algorithm is wasteful because it will spend time querying for services from UK ports where no services exist from such a port, or spend time considering routes to US ports only to find that no trucking service is available from those US ports to the final destination.

Another optional algorithm would involve computing in advance a database of all possible combinations of end-to-end routes, and storing all of these computed combinations in a database. Each route in such a database would comprise a list of freight services, for example: a trucking service with pickup in a 50 km radius around London Heathrow Airport (LHR) to LHR airport; a flight service from LHR to Chicago O'Hare airport (ORD); and a trucking service with pickup at ORD airport and delivery to a 100 km radius around Chicago.

However, many trucking companies and airlines have hundreds or even thousands of services available. Additionally, some trucking services are priced and offered separately for each zip code/postal code in a country. Thus, the combination of three or more legs quickly explodes into billions of routes which are impractical to store in a database. Even if all the routes can be practically stored in a large database, when a single service changes, it can take hours to update the potentially millions of effected routes that include that service. Such delays in updating data are highly undesirable.

U.S. Pat. No. 7,363,319 issued to Capellini on Apr. 22, 2008, the entire contents of which are incorporated herein by reference, is addressed to a search engine for searching transportation-related routes. A location system is used to determine nodes and optionally operational areas for each of the nodes. The system searches for paths in between nodes, the paths representing service providers who offer shipping services between two nodes, optionally according to user specified requirements.

The system of Capellini does not take into account business relationships between service providers or between service providers and clients. Additionally, the system of Capellini does not take into account resellers, who buy services from service providers and sell them to clients. Furthermore, the system of Capillini determines the operational area of each node either by input of relevant service providers or by geographical rules. Such a system does not take into account more complex operational areas, such as those associated with airports or seaports, and does not provide an efficient way to index geographical areas.

There is thus a long felt need for a cargo shipment route determination system and method which can provide improved shipment routes to users in real-time, taking into account vendor-customer and vendor-reseller-customer relationships, and providing for efficient matching of geographical areas.

### SUMMARY OF THE INVENTION

Accordingly, it is a principal object of the present invention to overcome the disadvantages of the prior art. This is accomplished in one embodiment by providing computer implemented cargo shipment route determining method, the method comprising: providing data regarding a plurality of shipment services, each shipment service datum comprising a service origin and service destination pair and further comprising price information; providing data regarding a plurality of shipment service providers, each shipment service associated with a particular one of the shipment service providers; providing a shipment origin of the cargo; providing a shipment destination of the cargo; responsive to the provided shipment origin, the provided shipment destination and a predetermined route viability criterion, identifying a viability set of the shipment services; responsive to a predetermined business relationship criterion, identifying a set of the shipment service providers; responsive to the identified shipment service viability set and the identified provider set, determining, in real-time, at least one shipment route for the cargo from the provided shipment origin to the provided shipment destination; responsive to the shipment service price information, determining, in real-time, price information associated with the determined at least one shipment route; and outputting the determined at least one shipment route and the determined associated price information.

In one independent embodiment, a non-transitory computer readable medium is provided, the non-transitory computer readable medium having instructions stored thereon, which, when executed by one or more processors, causes the one or more processors to perform operations, the operations comprising: providing data regarding a plurality of shipment services, each shipment service datum comprising a service origin and service destination pair and further comprising price information; providing data regarding a plurality of shipment service providers, each shipment service associated with a particular one of the shipment service providers; providing a shipment origin of the cargo; providing a shipment destination of the cargo; responsive to the provided shipment origin, the provided shipment destination and a predetermined route viability criterion, identifying a viability set of the shipment services; responsive to a predetermined business relationship criterion, identifying a set of the shipment service providers; responsive to the identified shipment service viability set and the identified provider set, determining, in real-time, at least one shipment route for the cargo from the provided shipment origin to the provided shipment destination; responsive to the shipment service price information, determining, in real-time, price information associated with the determined at least one shipment route; and outputting the determined at least one shipment route and the determined associated price information.

In another independent embodiment, a server is provided, the server comprises: a processor; a memory; and a communications module in communication with a plurality of user terminals. The memory has stored thereon: data regarding a plurality of shipment services, each shipment service datum comprising a service origin and service destination pair and further comprising price information; and data regarding a plurality of shipment service providers, each shipment service associated with a particular one of the shipment service providers. The communications module is arranged to receive a shipment origin of a cargo and a shipment destination of the cargo. The processor is arranged to: responsive to the received shipment origin, the received shipment destination and a predetermined route viability criterion, identify a viability set of the shipment services; responsive to a predetermined business relationship criterion, identify a set of the shipment service providers; responsive to the identified shipment service viability set and the identified provider set, determine, in real-time, at least one shipment route for the cargo from the received shipment origin to the received shipment destination; responsive to the shipment service price information, determine, in real-time, price information associated with the determined at least one shipment route; and output to the user terminal, via the communications module, the determined at least one shipment route and the determined associated price information.

In one independent embodiment, a computer implemented cargo shipment route determining method, the method comprising: providing data regarding a plurality of sets of hub-originating shipment services, each hub-originating shipment service datum comprising a service origin and service destination pair, the service origins of each set of hub originating shipment services corresponding to a particular one of a plurality of hubs; providing data regarding a plurality of sets of hub-destined shipment services, each hub-destined shipment service datum comprising a service origin and service destination pair, the service destinations of each set of hub destined shipment services corresponding to a particular one of the plurality of hubs; determining a catchment area for each of the plurality of hubs; providing a shipment origin of the cargo; providing a shipment destination of the cargo; identifying at least one of the hubs responsive to the determined catchment area containing the shipment origin; identifying at least one of the hubs responsive to the determined catchment area containing the shipment destination; identifying a shipment service from the hub-originating shipment service set associated with the selected at least one hub whose catchment area contains the shipment origin; identifying a shipment service from the hub-destined shipment service set associated with the selected at least one hub whose catchment area contains the shipment destination; determining, in real-time, at least one shipment route for the cargo from the received shipment origin to the received shipment destination responsive to: the shipment origin; the shipment destination; the identified hub-originating shipment service; and the identified hub-destined shipment service, and outputting the determined at least one shipment route.

In another independent embodiment, a non-transitory computer readable medium is provided, the non-transitory computer readable medium having instructions stored thereon, which, when executed by one or more processors, causes the one or more processors to perform operations, the operations comprising: providing data regarding a plurality of sets of hub-originating shipment services, each hub-originating shipment service datum comprising a service origin and service destination pair, the service origins of each set of hub originating shipment services corresponding to a particular one of a plurality of hubs; providing data regarding a plurality of sets of hub-destined shipment services, each hub-destined shipment service datum comprising a service origin and service destination pair, the service destinations of each set of hub destined shipment services corresponding to a particular one of the plurality of hubs; determining a catchment area for each of the plurality of hubs; providing a shipment origin of the cargo; providing a shipment destination of the cargo; identifying at least one of the hubs responsive to the determined catchment area containing the shipment origin; identifying at least one of the hubs responsive to the determined catchment area containing the shipment destination; identifying a shipment service from the hub-originating shipment service set associated with the selected at least one hub whose catchment area contains the shipment origin; identifying a shipment service from the hub-destined shipment service set associated with the selected at least one hub whose catchment area contains the shipment destination; determining, in real-time, at least one shipment route for the cargo from the received shipment origin to the received shipment destination responsive to: the shipment origin; the shipment destination; the identified hub-originating shipment service; and the identified hub-destined shipment service, and outputting the determined at least one shipment route.

In another independent embodiment, a server is provided, the server comprises: a processor; a memory; and a communications module in communication with a plurality of user terminals. The memory has stored thereon: data regarding a plurality of sets of hub-originating shipment services, each hub-originating shipment service datum comprising a service origin and service destination pair, the service origins of each set of hub originating shipment services corresponding to a particular one of a plurality of hubs; and data regarding a plurality of sets of hub-destined shipment services, each hub-destined shipment service datum comprising a service origin and service destination pair, the service destinations of each set of hub destined shipment services corresponding to a particular one of the plurality of hubs. The processor is arranged to: determine a catchment area for each of the plurality of hubs; receive from a user terminal, via the communications module, a shipment origin and shipment destination of the cargo; identify at least one of the hubs responsive to the determined catchment area containing the shipment origin; identify at least one of the hubs responsive to the determined catchment area containing the shipment destination; identify a shipment service from the hub-originating shipment service set associated with the selected at least one hub whose catchment area contains the shipment origin; identify a shipment service from the hub-destined shipment service set associated with the selected at least one hub whose catchment area contains the shipment destination; and determine, in real-time, at least one shipment route for the cargo from the received shipment origin to the received shipment destination responsive to: the shipment origin; the shipment destination; the identified hub-originating shipment service; and the identified hub-destined shipment service, and output to the user terminal, via the communications module, the determined at least one shipment route.

In one independent embodiment, a computer implemented cargo shipment route determining method is provided, the method comprising: providing data regarding a plurality of shipment services, each shipment service datum comprising a service origin and service destination pair, each of the service origins and service destinations determined as one of a predetermined plurality of area types; providing a shipment origin of the cargo; providing a shipment destination of the cargo; determining the location of each of the shipment origin and shipment destination according to each of the plurality of area types; comparing the shipment origin with the service origins in accordance with each of the plurality of area types to identify one of the service origins which contain the shipment origin; comparing the shipment destination with the service destinations in accordance with each of the plurality of area types to identify one of the service destinations which contain the shipment destination; determining, in real-time, at least one shipment route for the cargo from the received shipment origin to the received shipment destination responsive to: the identified service origin containing the shipment origin; or the identified service destination containing the shipment destination, and outputting the determined at least one shipment route.

In another independent embodiment, a non-transitory computer readable medium is provided, the non-transitory computer readable medium having instructions stored thereon, which, when executed by one or more processors, causes the one or more processors to perform operations, the operations comprising: providing data regarding a plurality of shipment services, each shipment service datum comprising a service origin and service destination pair, each of the service origins and service destinations determined as one of a predetermined plurality of area types; providing a shipment origin of the cargo; providing a shipment destination of the cargo; determining the location of each of the shipment origin and shipment destination according to each of the plurality of area types; comparing the shipment origin with the service origins in accordance with each of the plurality of area types to identify one of the service origins which contain the shipment origin; comparing the shipment destination with the service destinations in accordance with each of the plurality of area types to identify one of the service destinations which contain the shipment destination; determining, in real-time, at least one shipment route for the cargo from the received shipment origin to the received shipment destination responsive to: the identified service origin containing the shipment origin; or the identified service destination containing the shipment destination, and outputting the determined at least one shipment route.

In another independent embodiment, a server is provided, the server comprises: a processor; a memory; and a communications module in communication with a plurality of user terminals. The memory has stored thereon data regarding a plurality of shipment services, each shipment service datum comprising a service origin and service destination pair, each of the service origins and service destinations determined as one of a predetermined plurality of area types. The processor is arranged to: receive from a user terminal, via the communications module, a shipment origin and shipment destination of the cargo; determine the location of each of the shipment origin and shipment destination according to each of the plurality of area types; compare the shipment origin with the service origins in accordance with each of the plurality of area types to identify one of the service origins which contain the shipment origin; compare the shipment destination with the service destinations in accordance with each of the plurality of area types to identify one of the service destinations which contain the shipment destination; determine, in real-time, at least one shipment route for the cargo from the received shipment origin to the received shipment destination responsive to: the identified service origin containing the shipment origin; or the identified service destination containing the shipment destination, and output to the user terminal, via the communications module, the determined at least one shipment route.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level schematic diagram of a cargo shipment route determination system, according to certain embodiments;

FIG. 1B illustrates a high level block diagram of a processor and a memory of the system of FIG. 1A, according to certain embodiments;

FIG. 2A illustrates a high level flow chart of a method of operation of the system of FIGS. 1A-1B, according to certain embodiments;

FIG. 2B illustrates an example of a determined shipment route;

FIG. 2C illustrates a high level flow chart of optional stages in the method of FIG. 2A, according to certain embodiments;

FIG. 2D illustrates a high level flow chart of further optional stages in the method of FIG. 2A, according to certain embodiments; and

FIGS. 2E-2F illustrate high level schematic diagrams of examples of hub catchment areas.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

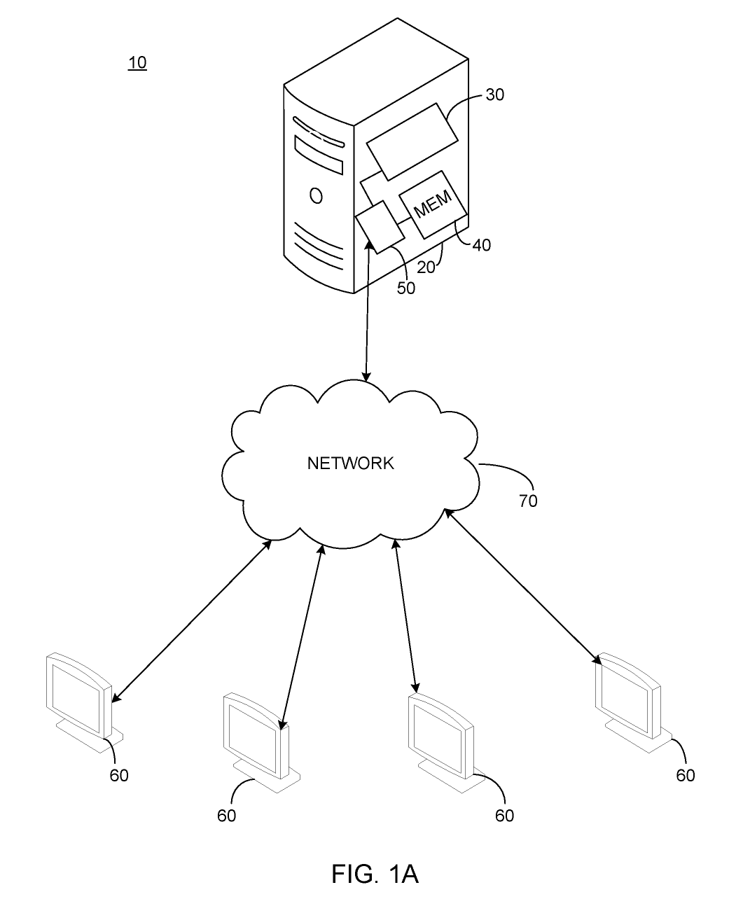

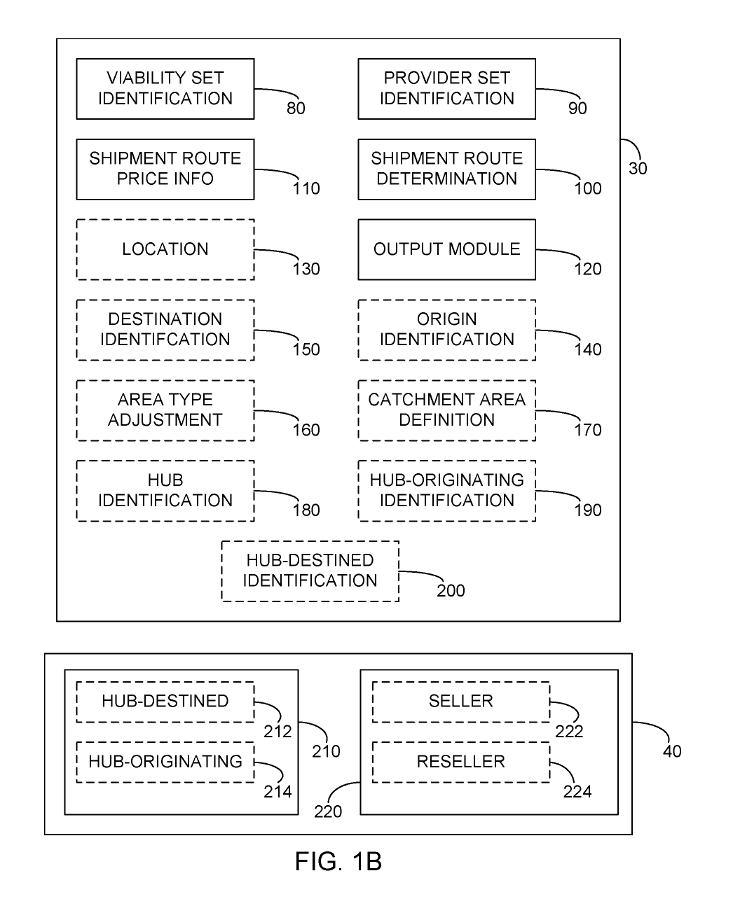

FIG. 1A illustrates a high level schematic diagram of a cargo shipment route determination system 10, comprising a server 20; and FIG. 1B illustrates a high level block diagram of a processor 30 and memory 40 of server 20, FIGS. 1A-1B being described together. Server 20 comprises: processor 30; memory 40; and a communications module 50. Communication module 50 of server 20 is in communication with a plurality of user terminals 60, over a network 70. In one embodiment, network 70 is the Internet. Processor 30 comprises: a viability set identification functionality 80; a provider set identification functionality 90; a shipment route determination functionality 100; a shipment route price determination functionality 110; an output module 120; an optional location functionality 130; an optional origin identification functionality 140; an optional destination identification functionality 150; an optional area type adjustment functionality 160; an optional catchment area determination functionality 170; an optional hub identification functionality 180; an optional hub-originating set identification functionality 190; and an optional hub-destined set identification functionality 200. The elements of processor 30 can each be implemented by any of: a dedicated functionality; computer readable instructions for a general purpose computing device or processor, the readable instructions stored on memory 40; dedicated hardware; and a dedicated control circuitry, without limitation. Memory 40 comprises: a shipment service portion 210, optionally comprising a hub-destined portion 212 and a hub-originating portion 214; and a shipment service provider portion 220, optionally comprising a seller portion 222 and a reseller portion 224. Memory 40 optionally comprises a master list of hubs, optionally including their catchment areas determined by optional catchment area determination functionality 170, as will be described below.

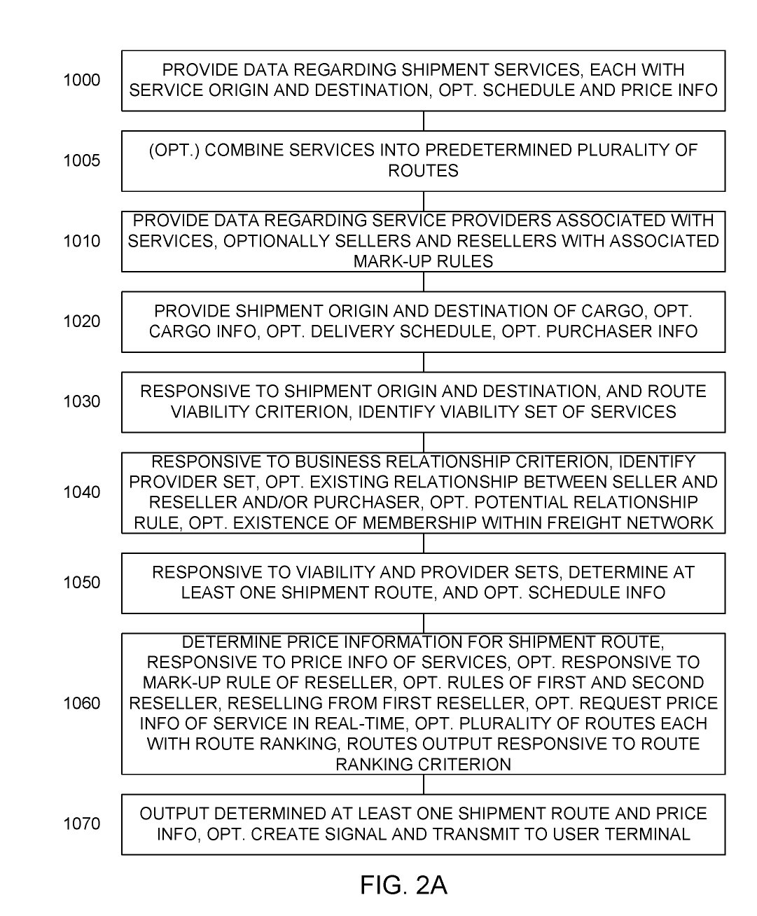

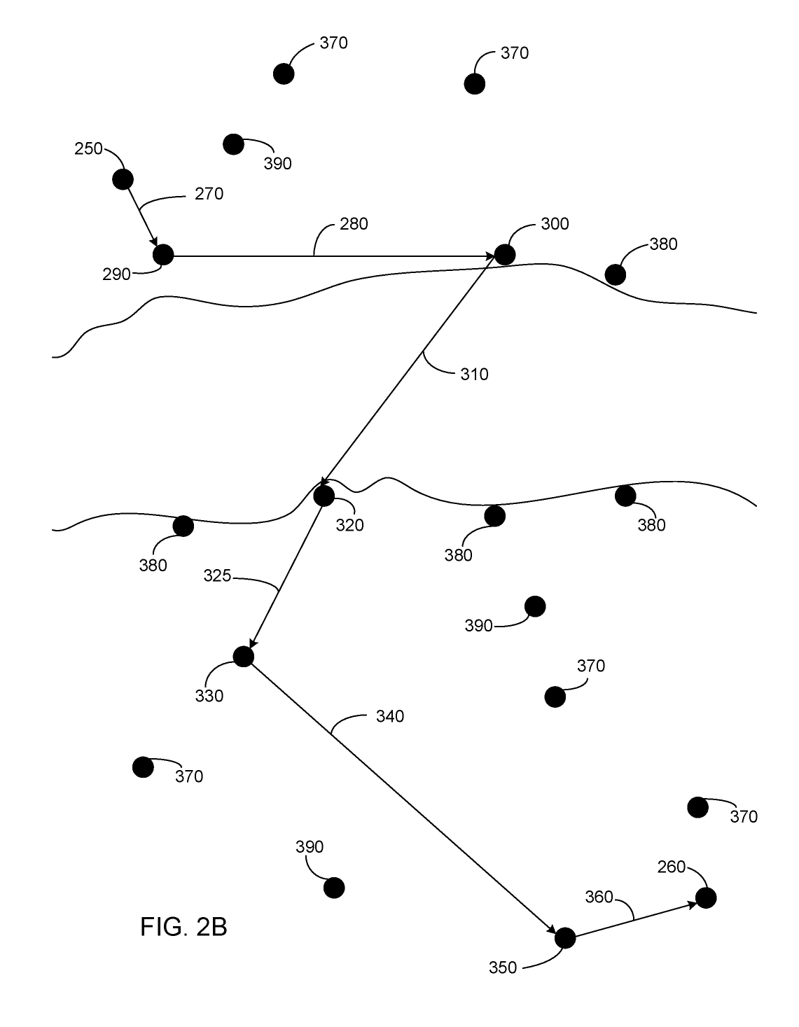

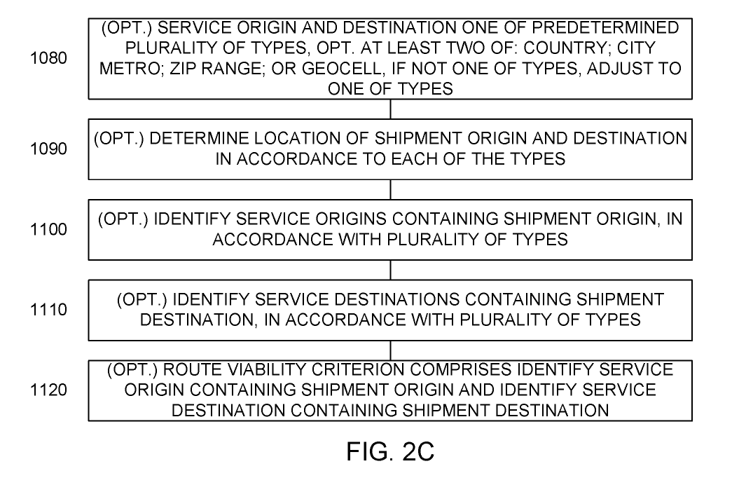

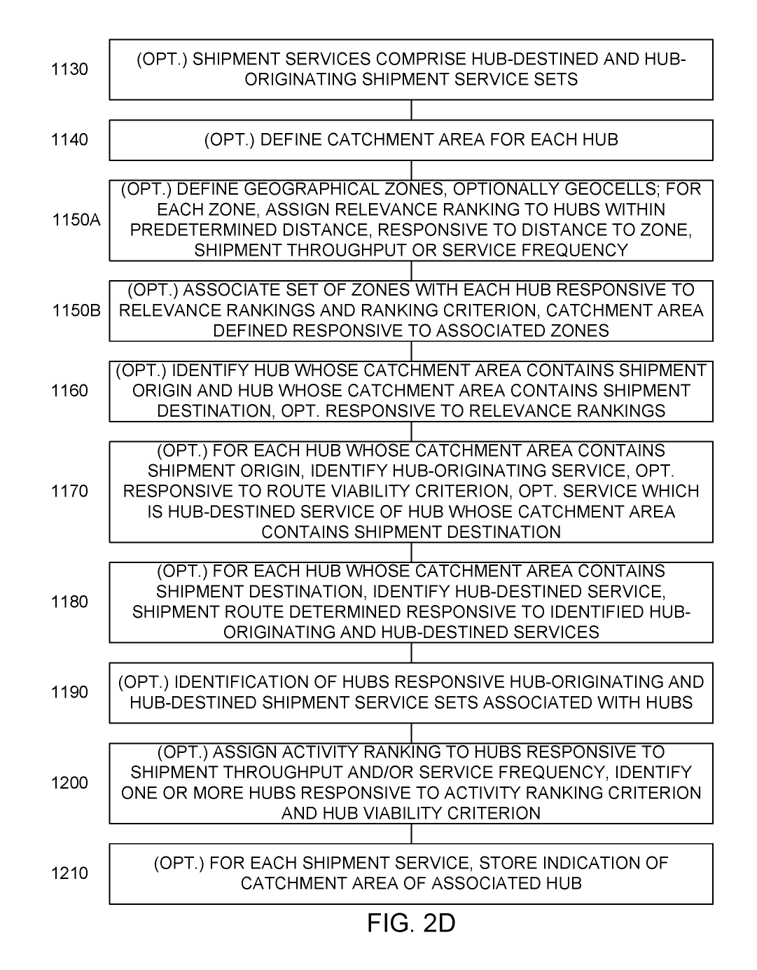

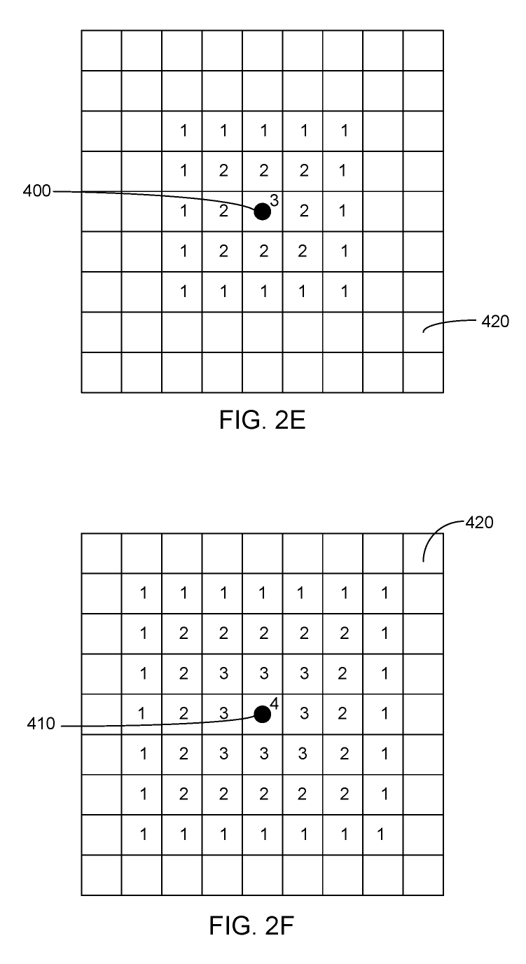

FIG. 2A illustrates a high level flow chart of a method of operation of system 10, according to certain embodiments. In stage 1000, data is provided regarding a plurality of shipment services. The datum for each shipment service is stored in shipment service portion 210 of memory 40 and comprises a service origin and service destination pair and optionally further comprises price information, schedule information, restrictions on the load type and dimensions information, vendor information, payment terms, carrier identity, seller information and/or criteria for potential purchasers. As further described below, if service is hub-originating, optionally data about the catchment area of the origin is copied to the service, and if the service is hub-destination, optionally data about the catchment area of the destination is copied to the service. Optionally, fields of the shipment service are indexed for quick retrieval using database indexing techniques known in the art. Fields that may be indexed, without limitation, include the service origin (or a code associated therewith such as an IATA airport code), the service origin catchment area (for example the geocells associated therewith), the service destination, the service destination catchment area, the dates on which the service is offered, the carrier and data about the seller. The term “shipment service” as used herein is meant to include, without limitation, any of: an offered shipment service from a first service area to a second service area, such as the service areas of a trucking service; and a particular shipment service departing from a hub (including a port, airport, depot, warehouse or container yard), such as a particular ship departing from a port, a particular flight departing from an airport, a particular rail service departing from a rail terminal, or a particular truck departing from a depot. The service origin and/or service destination of each shipment service may be a particular hub or may be a service area. In one embodiment, schedule information associated with each shipment service, such as departure/pick-up times, destination arrival times, or other schedule information, is stored in the shipment service datum.

In optional stage 1005, viable combinations of the shipment services of stage 1000 are combined into predetermined routes and stored on memory 40 for quicker retrieval. For example, a shipment service from LHR airport to John F. Kennedy International Airport (JFK), and a shipment service from JFK airport to Los Angeles International Airport (LAX) may be combined into a route which points at the original two shipment services, i.e. the shipment services departing from LHR and JFK, and indicates the possibility of sending freight from LHR to LAX.

In stage 1010, data regarding a plurality of shipment service providers is provided. The datum for each shipment service provider is stored in shipment service provider portion 220 of memory 40. Each shipment service provider is associated with at least one of the shipment services of stage 1000. In one embodiment, each shipment service provider is a shipment service seller. The term “shipment service seller” as used herein is defined as an entity which provides one or more shipment services and sells these shipment services to customers. For example, shipment service sellers may include, without limitation: a trucking service company selling truck based shipment services; an airline selling airplane based shipment services; a freight ship company selling ship based shipment services; a rail company; freight forwarders; freight consolidators; freight co-loaders; third party logistic providers (3PLs); and logistics integrators who sell freight services (whether or not they own or control the vessels involved), without limitation. In another embodiment, the plurality of shipment service providers comprises a plurality of shipment service sellers, the data associated therewith stored on seller portion 222 of memory 40, and a plurality of shipment service resellers, the data associated therewith stored on reseller portion 224 of memory 40. The term “shipment service resellers” as used herein is meant to define entities which purchase shipment services from shipment service sellers and sell the purchased shipment services to other entities. In one further embodiment, the datum of each shipment service reseller comprises a mark-up rule which indicates an amount, or percentage, which is added to the price of shipment services being resold thereby. In one embodiment, a plurality of mark-up rules are provided, each for: a different type of shipment service; specific different shipment services; a different type of shipment service sellers; different date ranges; different types of purchasers, or specific purchasers; or particular shipment service sellers, according to pre-existing business relationships between the shipment service reseller and the particular shipment service sellers.

Examples of markup rules include without limitation: adding a percentage to the total price; adding a percentage to specific fees only; adding a percentage subject to a minimum absolute amount; adding an amount per unit of weight; and adding an amount per TEU (twenty foot equivalent intermodal container).

In stage 1020, a shipment origin and shipment destination of a cargo is received from a user terminal 60, via communications module 50. In one embodiment, information about the cargo is additionally received, such as the weight and dimensions of the cargo, details of the type of cargo and the number of cargo units, dimensions of weight of each cargo unit (e.g. pallets) and details of the cargo contents (e.g. commodity codes according to the Harmonized System or HS codes). In another embodiment, the desired pick-up and or delivery schedule for the cargo is additionally received. In one embodiment, information regarding a shipment service purchaser associated with the cargo is received, such as their country of residence, credit rating and/or professional memberships. The term “shipment service purchaser” as used herein is defined as an entity who wishes to ship cargo via one or more shipment services. In another embodiment, the shipment service purchaser information is previously stored on memory 40.

In stage 1030, responsive to the provided shipment origin of stage 1020, the provided shipment destination of stage 1020 and a predetermined route viability criterion, viability set identification functionality 80 is arranged to identify a viability set of shipment services from the plurality of shipment services of stage 1000. Each shipment service of the identified viability set is viable for a shipment route for the cargo from the provided shipment origin to the provided shipment destination, i.e. one of these shipment services, or a combination of a plurality thereof, can be used for creating a shipment route for the cargo from the shipment origin to shipment destination within the limitations of the predetermined route viability criterion. In one embodiment, the identified viability set comprises origin corresponding shipment services whose service origin corresponds with the cargo shipment origin and destination corresponding shipment services whose service destination corresponds with the cargo shipment destination. In one further embodiment, the identified viability set further comprises shipment services which connect origin corresponding shipment services to destination corresponding shipment services, either directly or via other shipment services. Other validity criteria optionally include the nature, dimensions, weight, and contents of the cargo and/or the preferred shipment dates.

In one embodiment, the viability set is further identified by determining optional shipment routes. In particular, shipment route determination functionality 100 is arranged to determine if combinations of particular shipment services can form shipment routes from the received shipment origin to the received shipment destination, as described below in relation to stage 1050. In another embodiment, the viability set is further identified responsive to filtering shipment service providers according to business relationship criteria, as described below in relation to stage 1040.

Optionally, at this stage the indexing described above in relation to stage 1000 may be used to rapidly select a subset of the shipment services which may match the requested shipment. Optionally, fuzzy criteria may be used, such as selecting all shipment services which originate in the same country as the received shipment origin of stage 1020.

Optionally, at this stage pre-calculated routes of optional stage 1005 may be identified instead of determining indirect routes one shipment service at a time.

Alternatively, the shipment services stored on shipment service portion 210 may optionally be arranged in a graph. Standard algorithms known in the art for finding paths in a graph, such Bellman-Ford or Djikstra, may be used to find a route of services which connect the origin to the destination. Further optionally, hub origins and hub destinations of the shipment services, i.e. the particular hubs where the shipment services depart from and arrive to, are provided as common nodes in the graph, as will be described further below.

In stage 1040, responsive to a predetermined business relationship criterion, provider set identification functionality 90 is arranged to identify a set of shipment service providers. In one embodiment, the identification of a set of shipment service providers comprises identifying a set of shipment services responsive to their associated shipment service providers. In one embodiment, the set of shipment service providers is identified from among the shipment service providers associated with the identified viable shipment services of stage 1030. In one embodiment, the business relationship criterion comprises: an existing business relationship between one or more shipment service resellers and one or more shipment service sellers; and/or an existing business relationship between the shipment service purchaser associated with the cargo and any of the shipment service sellers or resellers. In another embodiment, the business relationship criterion comprises: one or more rules regarding potential business relationships between one or more shipment service resellers and one or more shipment service sellers; and/or one or more rules regarding potential business relationships between the shipment service purchaser associated with the cargo and any of the shipment service sellers or resellers. In one further embodiment, a potential business relationship rule comprises the existence of a membership of a purchaser, seller, and/or reseller with a particular freight network or other professional membership or qualification, including a credit rating, country of residence, or a customer rating. There is no requirement that stage 1040 be performed after stage 1030 and stage 1040 may be performed before stage 1030 without exceeding the scope. Additionally, as will be described below, there is no requirement that stage 1030 and stage 1040 be performed separately.

In one exemplary embodiment, shipment service provider portion 210 of memory 40 comprises information regarding at least ten service providers, each of the service providers providing at least ten shipment services, the information regarding the shipment services stored on shipment service portion 200 of memory 40, as described above. Thus, the operation of viability set identification functionality 80 and provider set identification functionality 90 filters through the at least 100 shipment services to provide information regarding a smaller amount of shipment services which can be quickly processed by shipment route determination functionality 100 and shipment route price information functionality 110. Optionally, the system filters through 10,000 potential combinations of two-leg routes, and optionally 1,000,000 potential combinations of three-leg routes (some of which may have been pre-calculated in optional stage 1005). In another exemplary embodiment, information regarding at least 100 service providers are provided, each providing thousands of shipment services at different times and over different routes to and from different places. Thus, the operation of viability set identification functionality 80 and provider set identification functionality 90 filters through the millions of shipment services to provide information regarding a smaller amount of shipment services which can be quickly processed by shipment route determination functionality 100 and shipment route price information functionality 110. Optionally, for each selected freight service where there is no direct relationship between the associated freight seller, and the freight purchaser associated with the cargo, multiple resellers are considered, including chains of resellers.

In stage 1050, responsive to the identified shipment service viability set of stage 1030 and further responsive to the identified shipment provider set of stage 1040, shipment route determination functionality 100 is arranged to determine at least one shipment route for the cargo from the received shipment origin and shipment destination of stage 1020. Viability set identification functionality 80, provider set identification functionality 90 and shipment route determination functionality 100 arranged such that the cargo shipment route is determined in real-time. The term “real time” as used herein is defined as the amount of time which is considered acceptable for requesting information from a server while a user is waiting for the result, from the time when the shipment origin and shipment destination is received by server 20 to the time that the at least one determined shipment route is output by shipment route determination functionality 100, or to the time that the determined at least one shipment route and determined associated price information is output by server 20, as will be described below. In one embodiment, “real-time” is less than 10 seconds.

In one embodiment, the at least one determined shipment routes comprises a plurality of shipment services, the service origin of a first shipment service corresponding to the cargo shipment origin (or a geographical region including the shipment origin, or a hub exhibiting a catchment area which includes the shipment origin, as will be described below), the service destination of a second shipment service corresponding to the cargo shipment destination (or a geographical region including the shipment destination, or a hub exhibiting a catchment area which includes the shipment destination, as will be described below) and the service origins and destinations of any other shipment services corresponding to each other. In another embodiment, shipment route determination functionality 100 is arranged to determine, in real-time, schedule information associated with each of the determined shipment routes, responsive to the stored schedule information associated with each shipment service.

The steps of stages 1030-1050 are described as 3 separate stages, however this is not meant to be limiting in any way. In particular, the viability set identification of stage 1030 is responsive to a determination of optional shipment routes which can be formed from combinations of shipment services, as described above.

In stage 1060, shipment route price information functionality 110 is arranged to determine price information associated with the determined at least one shipment route of stage 1050. The price information is determined responsive to the price information associated with each of the shipment services which are comprised within the determined shipment route. In one embodiment, where the shipment services of the determined shipment route are associated with one or more resellers, the price information includes the mark-up rules of each reseller. In one further embodiment, in stage 1040 described above, a first reseller is identified as a potential purchaser of one of the shipment services from an associated shipment service seller and a second reseller is identified as a potential purchaser of the shipment service from the first reseller. In such an embodiment, the shipment route price information is determined responsive to the pricing information of the potentially purchasable shipment service, the mark-up rule of the first reseller and the mark-up rule of the second reseller.

In one embodiment, shipment route price information functionality 110 is arranged to request from one or more of the identified shipment providers of stage 1050, via communications module 50, e.g. by calling a web service application programming interface (API) associated with the freight seller, price information regarding an associated shipment service, the shipment route price information determined responsive to the received shipment service price information. The request is performed in real-time, such that the price request does not significantly delay supplying the determined shipment route information to the client.

In another embodiment, pricing data for some or all of the shipment services is pre-stored in shipment service portion 210 of memory 40. Optionally, pricing data is imported into shipment service portion 120 from spreadsheets such as Microsoft Excel spreadsheets. Optionally, pricing data is divided into fees. Further optionally, fees may be associated with particular origins (e.g. an airport outbound handling charge), particular destinations (e.g. a seaport inbound handling charge), particular shipment services (e.g. the air freight fee associated with a particular daily flight service), particular service levels such as a premium three day service, particular carriers (such as the fuel surcharge fee associated with a given airline), and optional extra services such as documentation, insurance, customs brokerage, and particular dates or seasons.

Optionally, the fees may be charged per unit weight, per unit volume, per a predetermined combination of weight and volume according to a volumetric ratio, per unit of load (e.g. per pallet or per intermodal container or per TEU), as a percentage of other fees, per number of commodities in the shipment, per value of the shipment, or by date, without limitation. Fees are optionally subject to a minimum. Different fees optionally apply for different ranges of values. For example, air freight is often charged per kilogram with a different per kg rate for 0-45 kg, 45-100 kg, 100-200 kg, etc.

In one embodiment, a plurality of shipment routes are determined, each of the plurality of determined shipment routes exhibiting a different advantageous feature, such as: lower price; improved schedule; preferred seller; availability of extra services such as insurance or customs brokerage; proximity of requested origin to actual route origin and of requested destination to actual route destination; or any other predetermined criteria. In one further embodiment, a route ranking is assigned to each of the determined shipment routes responsive to the determined schedule and pricing information of each of the determined shipment routes and further responsive to a predetermined pricing and scheduling criterion. Optionally, the predetermined pricing and scheduling criterion is responsive to information received by the client associated with the cargo, either with the current shipment request or at an earlier date. The predetermined pricing and scheduling criterion comprises information regarding the client's preferences regarding pricing and scheduling, the route ranking assigned in accordance with these preferences. In one embodiment, server 20 is arranged to output to the client only those determined shipment routes exhibiting a route ranking which meets a predetermined route ranking criterion.

In stage 1070, output module 120 is arranged to output the determined at least one shipment routes of stage 1050 and the associated seller, schedule and pricing information. In one embodiment, output module 120 is arranged to generate a signal containing the at least one determined shipment route and associated pricing information, the signal transmitted via communications module 50 to the user terminal 60 which sent the shipment route request.

Methods of communication optionally include one or more of a web service, representation state transfer hypertext transfer protocol POST (RESTful HTTP POST), embedding in an html web page transmitted to a browser, remote procedure call, and an electronic data interchange (EDI), without limitation.

FIG. 2B illustrates an example of a determined shipment route comprising a plurality of shipment services and associated sellers and resellers. A cargo needs to be shipped from shipment origin point 250 to shipment destination point 260. According to a route to be determined by the system, the cargo shall be first transported by a truck 270 operated by a trucking service which has a service area incorporating shipment origin point 250. Truck 270 transports the cargo from origin point 250 to a freight train 280. Freight train 280 departs from a train station 290 and arrives at a harbor (seaport) 300. The cargo is loaded onto a ship 310 departing harbor 300 and arriving at a harbor 320. The cargo is then loaded onto a truck 325 which transports the cargo to an airport 330. The cargo is loaded onto an airplane 340 departing airport 330 and arriving at airport 350. The cargo is then loaded onto a truck 360 operated by a trucking service, which has a service area incorporating shipment destination point 260, and transported to destination point 260.

The transportation on truck 270 is purchased from the associated truck provider. The transportation on train 280 is purchased from a freight train transportation reseller which purchases freight allotments on trains departing from train station 290 and the transportation on ship 310 is purchased from a cargo ship transportation reseller which purchases cargo allotments on ships departing from harbor 300. The transportation on truck 325 is purchased from a trucking transportation reseller which purchases freight allotments on trucks departing from harbor 320. The transportation on airplane 340 and truck 360 is purchased from a multi-service reseller. The multi-service reseller purchases the transportation on airplane 340 from an air flight reseller, such as a freight consolidator or co-loader, who purchases cargo allotments on airplanes departing from airport 330. The multi-service reseller further purchases the freight allotment on truck 360 from the associated trucking service.

Optionally a further reseller, such as a freight forwarder or third party logistics provider (3PL) purchases all of the above services and then resells them as a single integrated service with a single invoice to the purchaser associated with cargo.

As illustrated, the cargo could have been shipped via any number of airports 370, harbors 380 and train stations 390, utilizing a plurality of trucking services at any given point. Advantageously, server 20 provides for a system of providing real-time shipment route determination from the thousands, or even millions or billions, of shipment possibilities. As described above, only specific shipment services are identified, particularly shipment services which are: viable for forming a shipment route from shipment origin point 250 to shipment destination point 260; and are provided by shipment service sellers or resellers which meet the predetermined business relationship criteria and criteria for matching the cargo. Thus, the number of options for forming shipment routes is significantly decreased, allowing processor 30 to determine shipment routes in real-time.

The pricing includes fees associated with each service and hub of the shipment route responsive to the dates, the cargo and the identity of the purchaser. The pricing also includes markups for all the resellers involved. The schedule data includes data for all of the shipment services along the shipment route. The pricing and schedule data allows this shipment route to be compared to other shipment routes, as described above in relation to stage 1060.

FIG. 2C illustrates a high level flow chart of optional stages in the method of operation of server 20, in particular for matching the requested shipment origin to the first shipment service in the shipment route and for matching the requested shipment destination with the last shipment service. In optional stage 1080, the service origin and service destination of each stored shipment service is defined as one of a predetermined plurality of area types. In particular, the service origin area reflects the area from where a service provider provides a shipment service, e.g. the area where a trucking service provides cargo pick up, and the service destination area reflects the area to where a service provider provides a shipment service, e.g. the area where a trucking service provides cargo delivery. In one embodiment, the predetermined plurality of area types consist of at least two of: a country; a city metro area; a zip code range; and a geocell.

The service area is in one embodiment provided by the associated service provider, therefore different service providers may provide different service area types. In the event that the area type of any of the received service origins and service destinations is not one of the predetermined plurality of area types, optional area type adjustment functionality 160 is arranged to adjust the received service origin or service destination to correspond to one of the predetermined plurality of types. For example, in the event that the service provider provides a geometrically shaped service area, such as a circular area with a particular radius around a particular hub (say 100 km around LHR airport), optional area type adjustment functionality 160 is in one embodiment arranged to define the service area as a plurality of geocells which contain the provided circle. In one embodiment, the service area is defined as a close approximation, e.g. the smallest possible plurality of geocells of a certain size which comprise the entire circle. In such an embodiment, the adjusted service area is larger than the actual service area and there is a possibility of false matches which will be filtered out later.

In one embodiment, the shipment services are stored such that their service origin and service destination areas are indexed for quick retrieval. Optionally, shipment services exhibiting similar service origins or service destinations are grouped together or exhibit a common tag. Optionally, shipment services exhibiting service origins and service destination of a common area type are grouped together or exhibit a common tag.

In optional stage 1090, optional location functionality 130 is arranged to determine the location of the received shipment origin and the location of the received shipment destination of stage 1020, according to each of the plurality of area types, i.e. the shipment origin and shipment destination is converted to each of the plurality of area types. For example, in one embodiment the shipment origin and shipment destination are each provided as an address, or alternatively as a latitude and longitude. Optional location functionality 130 is arranged to extract the relevant area type information from the address, e.g. the country, city metro area, and all zip code ranges and geocells which contain the particular address.

For example, a given address in London with postal code NW1 ABC is contained in: the country with standard code GB; a metropolitan city area that is optionally coded as CITY_GB_LONDON; postal code ranges based on their prefixes which are optionally encoded as ZIP_GB_NW1_ABC, ZIP_GB_NW1_AB and ZIP_GB_NW1, ZIP_GB_NW (optionally prefixes which split between the initial letters ZIP_GB_N are avoided); and geocells within a predetermined range of lengths, optionally 2-4 hexidecimal characters, such as EF5A, EF5, EF.

In optional stage 1100, optional origin identification functionality 140 is arranged to identify all the service origin areas of the shipment services stored on shipment service portion 210 of memory 40, in accordance with the plurality of standardized area types, containing the shipment origin. In one embodiment, the service origin identification is performed by comparing the shipment origin with the service origin areas of the shipment services, the comparison performed in accordance with the predetermined types, e.g. if a service origin is give as a particular country, then the country of the shipment origin is compared to the service origin. As described above in relation to stage 1080, in one embodiment the shipment services are stored such that the standardized areas associated with their service origins are indexed, thereby it isn't necessary to compare the shipment origin with each and every shipment service and a comparison with groups of shipment services exhibiting the same service origins is sufficient.

In optional stage 1110, optional destination identification functionality 150 is arranged to identify all the service destination areas of the shipment services stored on shipment service portion 210 of memory 40, in accordance with the plurality of standardized area types, containing the shipment destination. In one embodiment, the service destination identification is performed by comparing the shipment destination with the service destination areas of the shipment services, the comparison performed in accordance with the predetermined types, e.g. if a service destination is give as a particular country, then the country of the shipment destination is compared to the service destination.

In optional stage 1120, the route viability criterion of stage 1030 comprises identifying one or more service origins containing the shipment origin or one or more service destinations containing the shipment destination, as described above. In particular, viability set identification functionality 80 is arranged to identify the viable shipment services responsive to the comparisons of optional stages 1100 and 1110.

FIG. 2D illustrates a high level flow chart of optional stages in the method of operation of server 20. In optional stage 1130, the plurality of provided shipment services of stage 1000 comprises a plurality of sets of hub-destined shipment services, the service destinations of the shipment services of each hub-destined shipment service set corresponding to a particular one of a plurality of hubs, i.e. the shipment services of each set have the same hub as their destination point. For example, a plurality of airline flights, each arriving at John F. Kennedy International Airport (JFK), are each tagged as a hub-destined shipment service associated with the JFK airport hub. As described above, in one embodiment the shipment services are stored in a graph and JFK airport is a common node in the graph, representing the service destination of each of the shipment services connected to the common node. The plurality of provided shipment services of stage 1000 further comprises a plurality of sets of hub-originating shipment services, the service origins of the shipment services of each hub-originating shipment service set corresponding to a particular one of a plurality of hubs, i.e. the shipment services of each set have the same hub as their origin point. For example, a plurality of airline flights, each departing from London Heathrow Airport (LHR), are each tagged as a hub-originating shipment service set associated with the LHR airport hub. As described above, in one embodiment the shipment services are stored in a graph and LHR airport is a common node in the graph, representing the service origin of each of the shipment services connected to the common node. Each hub-based shipment service, such as air flights, ships, trains and trucks which ship only between depots, is thus associated with a pair of hubs.

Optionally, a master list of hubs is stored on memory 40, such as the United Nations (UN) Location Code list of airports, seaports and other hubs.

In optional stage 1140, catchment area determination functionality 170 is arranged to determine a catchment area for each of the plurality of hubs of optional stage 1130, the catchment area for each hub stored on memory 40. Preferably, the catchment area for each hub is determined in advance, such that all the catchment areas are already determined when a cargo shipment origin and shipment destination is received. A method of determining hub catchment areas is described in optional stages 1150A-1150B.

In optional stage 1150A, a plurality of geographical zones are defined, the geographical zones optionally defined utilizing a GeoModel known in the art such as geohashes or geocells which assign a label to approximately rectangle areas of the planet's surface, using longer labels to subdivide each rectangle into smaller rectangles. Preferably, each zone reflects an area of less than 10,000 km². Preferably, the geographical zones are defined as geocells which split the planet into 16⁴ equal zones. Optionally, geocells which contain only ocean water are not utilized, the ocean zones optionally identified utilizing a Mercator Projection map of Earth to see if the zone is purely blue.

For each of the defined geographical zones, a relevance ranking is assigned to each of the hubs within a predetermined distance of the geographical zone. The relevance ranking is assigned responsive to: the distance between the geographical zone and the hub; the shipment throughput of the hub, i.e. how much cargo is shipped through the particular hub during a predefined time period, such as a year; and/or the operation frequency of the associated hub-destined shipment service set and/or the associated hub-originating shipment service set, i.e. how often shipment services depart from and/or arrive at the particular hub. In one embodiment, the hub operation frequency is determined based on the average operating frequency of the associated shipment services. In another embodiment, the distance, the shipment throughput and the shipment service operation frequency are each applied a predetermined weight such that a single relevance ranking is assigned. In one further embodiment, the relevance ranking is adjusted responsive to country borders between the zone and the hub, preferably responsive to known border crossing difficulties (for example crossing a border between two EU countries would be assigned a smaller negative weight than crossing between two countries at war with each other).

Optionally, a relevance ranking is assigned only to hubs within a predetermined distance of the geographical zone, which would reflect the maximum distance one would consider trucking cargo to a hub. In one embodiment, the predetermined distance is about 2,000 Km. In another embodiment, a different distance is applied for airports than seaports since seaports are typically farther away as they are only located on sea coasts. In one embodiment, hubs are filtered responsive to large geocells, i.e. hubs which are not in the large geocell, or a neighboring large geocell, aren't considered, without having to check each high resolution geocell.

In one embodiment, optional catchment area determination functionality 170 is further arranged to associate with each geographical zone only hubs which meet a predetermined relevance ranking criterion, the predetermined criteria optionally being one or more of: associating the 3 hubs with the highest relevance rankings; associating any hub whose relevance ranking is at least 80% of the highest relevance rankings of any of the hubs; associating at least one hub exhibiting a relevance ranking greater than a predetermined value; and associating any hub which is within a predetermined distance from the center of the zone, optionally 200 km. Optionally, the above predetermined criteria are utilized for each of a different type of hub. For example, 3 seaports and 3 airports are associated with each zone. The predetermined criteria have been described where a high relevance ranking represents a more relevant hub, however this is not meant to be limiting in any way.

It will be appreciated that this stage provides data about which hubs would be considered relevant for shipping cargo to/from addresses in the given geocell. In one embodiment, a list of the defined zones is stored on memory 40, each zone having associated therewith the relevance rankings of the associated hubs.

In optional stage 1150B, a set of the defined geographical zones is associated with each of the hubs responsive to the assigned relevance rankings, the catchment area of each hub determined responsive to the associated geographical zone set. In one embodiment, the catchment area of each hub comprises whichever geographical zones were associated to this hub at the stage above. Optionally, the determined catchment area information further comprises the relevance rankings of each associated zone. In particular, the relevance ranking assigned to the hub in stage 1150A for a specific zone is now assigned to the specific zone as part of the catchment area of the hub. For example, in stage 1150A, hub JFK received a relevance ranking of “1” in relation to zone “A”. Thus, the catchment area of hub JFK will comprise zone “A”, and zone “A” is assigned a relevance ranking of “1”.

In one embodiment, in the event that a catchment area comprises 16 contiguous geocells, such as the 16 four character geocells ‘abc0’ . . . ‘abcf’, this list is consolidated into a larger three character geocell ‘abc’ to improve performance. Thus, 4-character geocells can in some cases be consolidated into 3-character geocells. Optionally, ocean geocells which were previously disregarded can be added to help make up a set of 16 geocells for consolidation. In another embodiment, the catchment area for each of the hubs is recalculated every predetermined time period, such as every few months or years, and optionally is recalculated every time a new hub is built, or a hub is closed, or when new data is available about hub throughput, or when situations change with regards to driving distances and border crossing difficulty.

An example of catchment areas of a hub 400 and a hub 410 are illustrated in FIGS. 2E-2F. As illustrated in FIG. 2E, a hub 400 is surrounding by a plurality of zones 420. The zone containing hub 400 has an assigned relevance ranking of “3”. The zones surrounding the center zone have an assigned relevance ranking of “2”, as they are farther away from hub 400. The zones surrounding the “2” ranked zones have an assigned relevance ranking of “1”. The rest of the zones are considered too far from hub 400 and therefore are not part of its catchment area. For example, these are zones from where it would not be economically feasible to truck cargo to hub 400. It will be appreciated that an advantage of this algorithm is that catchment areas are based on relative proximity of hubs. Therefore, catchment areas of hubs are not necessarily uniformly shaped and may exclude zones which have more efficient hubs in the vicinity. For example, in some cases a seaport such as Long Beach Calif. may have a catchment area reaching thousands of kilometers inland, since no closer seaport is available. In another example, the catchment area of Atlanta International Airport (ATL) may extend over 1,000 km westward, however the catchment area will extend significantly less southward since Miami International Airport, which is a major airport, would be closer for shipment origins and destinations in the vicinity of Miami. On the other hand a point just a few hundred kilometers up the coast might not be included since closer ports are available. The algorithm also takes into account that it is worthwhile to drive further to an airport which is not closest but which is larger and has more flight options, as described below in relation to optional stage 1200.

As illustrated in FIG. 2F, a hub 410 is surrounding by a plurality of zones 420. The zone containing hub 410 has an assigned relevance ranking of “4”. This zone has a higher ranking the zone containing hub 400 because hub 410 has a shipment throughput greater than the shipment throughput of hub 400. The zones surrounding the center zone have an assigned relevance ranking of “3”, as they are farther away from hub 410. The zones surrounding the “3” ranked zones have an assigned relevance ranking of “2”, and the zones surrounding the “2” ranked zones have an assigned relevance ranking of “1”. The rest of the zones are considered too far from hub 410 and therefore are not part of its catchment area. As described above, the relevance rankings of zones 420 are optionally not stored with the information regarding the catchment area of hub 410. Rather, the relevance ranking of each hub is stored in association with each of the zones. In the example of FIG. 2F, each zone 420 has associated therewith the relevance ranking of hub 410. In particular, the zone 420 containing hub 410 has associated therewith the relevance ranking of hub 410, i.e. “4”, and further has associated therewith the relevance rankings of additional hubs (not shown).

In optional stage 1160, optional hub-identification functionality 180 is arranged to identify at least one of the hubs whose catchment area contains the shipment origin of stage 1020 and at least one of the hubs whose catchment area contains the shipment destination of stage 1020. In one embodiment, if there are a plurality of hubs whose catchment areas contain the shipment origin or shipment destination, hubs will be identified in accordance with the relevance ranking of the zone containing the shipment origin or shipment destination. Optionally, only a predetermined number of hubs will be selected, the hubs selected responsive to the relevance rankings.

In optional stage 1170, for each of the identified hubs of optional stage 1160 whose catchment area contains the shipment origin, optional hub-originating set identification functionality 190 is arranged to identify one or more shipment services from the associated hub-originating shipment service set. In one embodiment, the one or more shipment service are identified responsive to the route viability criterion described above in relation to stage 1030. In another embodiment, the one or more shipment services are identified responsive to those shipment services which are also associated with the hub-destined shipment service sets of the one or more identified hubs whose catchment area contains the shipment destination, i.e. a shipment service which departs from a hub whose catchment area contains the shipment origin and arrives at a hub whose catchment area contains the shipment destination. The identified shipment services. For example, in the event that the catchment area of hub LAX contains the shipment origin and the catchment area of hub LHR contains the shipment destination, any flights which depart from LAX and also arrive at LHR will be identified. In one embodiment, as will be described below in relation to optional stage 1200, optional hub-originating set identification functionality 190 is arranged to identify shipment services which arrive at an intermediate hub, the intermediate hub having associated therewith shipment services which arrive at a hub whose catchment area contains the shipment destination. For example a route from LAX to JFK to LHR may be identified.

In optional stage 1180, for each of the identified hubs of optional stage 1160 whose catchment area contains the shipment destination, optional hub-destined set identification functionality 200 is arranged to identify a shipment service from the associated hub-destined shipment service set, as described above in relation to optional hub-originating set identification functionality 190 of optional stage 1070. Shipment route determination functionality 100 is thus arranged to determine at least one shipment route responsive to the identified hub-originating shipment services of optional stage 1070 and the identified hub-destined shipment services of optional stage 1080. Thus, optional stages 1180 and 1190 provide for an identification of shipment services departing the hub whose catchment area contains the shipment origin and shipment services arriving at the hub whose catchment area contains the shipment destination. A shipment route can be determined responsive to the identified hub-based shipment services, either with a direct connection between the two hubs, i.e. via a shipment service originating from the origin hub and arriving at the destination hub, or with a non-direct connection.

In optional stage 1190, the arrangement of optional hub-identification functionality 180 to identify one or more hubs whose catchment area contains the shipment origin, as described in relation to optional stage 1160, is further responsive to the hub-originating shipment service sets associated with the hubs. In particular, optional hub-identification functionality 180 is arranged to filter out hubs who don't have associated therewith any shipment services who arrive at a hub whose catchment area contains the shipment destination or who arrive at an intermediate hub which has at least one shipment service who arrive at the destination hub, i.e. hubs who don't have any shipment services which are viable for forming a shipment route from the shipment origin to the shipment destination. Similarly, the arrangement of optional hub-identification functionality 180 to identify one or more hubs whose catchment area contains the shipment destination, as described in relation to optional stage 1160, is further responsive to the hub-destined shipment service sets associated with the hubs.

In optional stage 1200, optional catchment area determination functionality 170 is further arranged to assign an activity ranking to each of the hubs, the activity ranking assigned responsive to the shipment throughput of the hub and/or the operation frequency of shipment services destined to or originating from the hub. Optional hub identification functionality 180 is further arranged to identify one or more of the hubs responsive to the assigned activity ranking and an activity ranking criterion, and further responsive to a hub viability criterion. In one embodiment, the activity ranking of each hub is incorporated within the relevance ranking of each hub. In particular, the relevance ranking of each hub comprises the activity ranking of the hub and the distance from the particular zone, as described above. In one embodiment, the activity ranking criterion comprises identifying a hub exhibiting an activity ranking representing shipment throughput and/or shipment service operation frequency greater than a predetermined value, i.e. representing a major hub. In the embodiment where an activity ranking is not separately assigned, rather it is incorporated within the relevance ranking, the hub is identified responsive to the shipment throughput and/or shipment service operation of the relevance ranking. In another embodiment, the hub viability criterion comprises identifying a hub who has associated therewith shipment services which connect the hub with a hub whose catchment area contains the shipment origin and shipment services which connect the hub with a hub whose catchment area contains the shipment destination.

Shipment route determination functionality 100 is thus arranged to determine at least one shipment route responsive to the identified hub-originating shipment services and hub-destined shipment services associated with a major hub. Advantageously, major hubs provide more options of shipment services. Therefore, shipping the cargo from a small hub which is close to the shipment origin to a small hub which is close to the shipment destination, via a major hub, will provide more options for selecting shipment services than by shipping directly between the smaller hubs, the greater amount of options providing greater flexibility in shipping schedule and pricing.

It should be noted that, for example, for a shipment request from an address in Los Angeles, Calif. to an address in London, UK, the above algorithm will rapidly identify the relevant hub-to-hub services such as LAX to LHR. An optional stage will then search for a trucking service from the shipment origin to LAX and a trucking service from LHR to the shipment destination in order to provide a door-to-door route. If such trucking services cannot be found the system can optionally offer a route which is from LAX or to LHR as a “nearby suggestion” for the requested route.

In optional stage 1210, for each of the hub-originating shipment services, an indication of the catchment area of the associated hub is stored in the respective shipment service datum, i.e. the service origin includes the catchment area of the associated hub. Additionally, for each of the hub-destined shipment services, an indication of the catchment area of the associated hub is stored in the respective shipment service datum, i.e. the service destination includes the catchment area of the associated hub. In one embodiment, the catchment area data is indexed using database indexing techniques known in the art. Advantageously, this allows for rapid identification of relevant shipment services responsive to the associated catchment area. In particular, viable shipment services can be identified by comparing the shipment origin and shipment destination with the catchment area of the associated origin hub and the associated destination hub of the shipment service.

For example when searching for a route from an address in Los Angeles, Calif., to an address in London, England, the system first determines the geocells (of pre-determined lengths such as 3 and 4 hexadecimal characters) containing this origin address and destination address. The system then searches the database for shipment services which have origins with catchment areas including the geocells containing the shipment origin and with destinations with catchment areas including the geocells containing the shipment destination. This may be done very rapidly as a shipment service containing a flight from LAX to LHR is stored with all the geocells of the catchment areas of these respective ports. Thus the system may very rapidly match a flight from LAX to LHR as relevant to the requested shipment.

Server 20 is thus arranged to determine shipment routes by identifying hub-to-hub shipment services, responsive to the hub catchment areas, and further identifying shipment services for shipping the cargo to and from the end ports. Advantageously, this significantly reduces the amount of identified shipment services, as there is only a limited number of viable hub-based shipment services, and only a limited number of shipment services from the shipment origin to the origin hub and from the destination hub to the shipment destination.

In the example described above in FIG. 2B, processor 20 received shipment origin point 250 and shipment destination point 260. Train 280, ship 310 and airplane 340 are rapidly identified responsive to the catchment areas of the associated hubs: train station 290; harbors 300 and 320; and airports 330 and 350, respectively. Processor 20 further identifies trucks 270, 325 and 360 for shipping cargo to and from the relevant hubs. In one embodiment, as described above, some combinations of these shipment services were optionally pre-stored as routes.

The above has been described in an embodiment where location functionality 130, origin identification functionality 140, destination functionality 150, area type adjustment functionality 160, catchment area determination functionality 170, hub identification functionality 180, hub-originating set identification functionality 190 and hub-destined set identification functionality 200 are each optional, however this is not meant to be limiting in any way. In another embodiment, location functionality 130, origin identification functionality 140 and destination functionality 150 are not optional, and similarly stages 1080-1120 of FIG. 2C are not optional. Optionally, in such an embodiment, provider set identification functionality 90 is provided as an optional functionality, and similarly stage 1010 and 1040 of FIG. 2A are optional. In another embodiment, catchment area determination functionality 170, hub identification functionality 180, hub-originating set identification functionality 190 and hub-destined set identification functionality 200 are not optional, and similarly stages 1130, 1140 and 1160-1200 of FIG. 2D are not optional. Optionally, in such an embodiment, provider set identification functionality 90 is provided as an optional functionality, and similarly stage 1010 and 1040 of FIG. 2A are optional.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1-36. (canceled)

37. A cargo shipment route determination server comprising:
a processor;
a memory; and
a communications module in communication with a plurality of user terminals,
wherein said memory has stored thereon data regarding a plurality of hubs, and
wherein said processor is arranged, responsive to instructions stored on said memory, to:
determine a catchment area for each of said plurality of hubs;
receive from a user terminal, via said communications module, a shipment origin and shipment destination of the cargo;
determine, in real-time, at least one shipment route for the cargo from said received shipment origin to said received shipment destination responsive to said shipment origin, said shipment destination and said determined catchment area for one said plurality of hubs; and
output to the user terminal, via said communications module, an indication of said determined at least one shipment route.

38. The server of claim 37, wherein said processor is further arranged, responsive to said instructions, to:
determine a plurality of geographical zones;
for each of said determined geographical zones, assign a relevance ranking to each of said hubs within a predetermined distance of said geographical zone; and
associate a set of said determined geographical zones with each of said hubs responsive to said assigned relevance rankings and further responsive to a relevance ranking criterion, said catchment area of said hub determined responsive to said associated geographical zone set.

39. The server of claim 38, wherein said relevance ranking is assigned responsive to:
the distance between said geographical zone and said hub;
the shipment throughput of said hub; or
the operation frequency of hub-destined shipment services or hub-originating shipment services associated with said respective hub.

40. The server of claim 37, wherein said catchment area determination is performed prior to said receipt of the cargo shipment origin and destination.

41. The server of claim 37, wherein said memory further has stored thereon:
data regarding a plurality of sets of hub-originating shipment services, each hub-originating shipment service datum comprising a service origin and service destination pair, said service origins of each set of hub originating shipment services corresponding to a particular one of said plurality of hubs; and
data regarding a plurality of sets of hub-destined shipment services, each hub-destined shipment service datum comprising a service origin and service destination pair, said service destinations of each set of hub destined shipment services corresponding to a particular one of said plurality of hubs,
wherein said processor is further arranged, responsive to said instructions, to:
identify one of said hubs responsive to said determined catchment area containing said shipment origin or said shipment destination;
identify a shipment service from said hub-originating shipment service set associated with said identified hub whose catchment area contains said shipment origin or from said hub-destined shipment service set associated with said identified hub whose catchment area contains said shipment destination, and
wherein said shipment route determination is further responsive to said identified hub-originating shipment service or hub-destined shipment service.

42. The server of claim 37, wherein said memory further has stored thereon:
data regarding a plurality of sets of hub-originating shipment services, each hub-originating shipment service datum comprising a service origin and service destination pair, said service origins of each set of hub originating shipment services corresponding to a particular one of said plurality of hubs; and
data regarding a plurality of sets of hub-destined shipment services, each hub-destined shipment service datum comprising a service origin and service destination pair, said service destinations of each set of hub destined shipment services corresponding to a particular one of said plurality of hubs,
wherein said processor is further arranged, responsive to said instructions, to:
identify at least one of said hubs responsive to said determined catchment area containing said shipment origin;
identify at least one of said hubs responsive to said determined catchment area containing said shipment destination;
identify a shipment service from said hub-originating shipment service set associated with said identified at least one hub whose catchment area contains said shipment origin;
identify a shipment service from said hub-destined shipment service set associated with said identified at least one hub whose catchment area contains said shipment destination, and
wherein said shipment route determination is further responsive to said identified hub-originating shipment service an said identified hub-destined shipment service.

43. The server of claim 42, wherein said identified hub-originating shipment service and said identified hub-destined shipment service are the same.

44. The server of claim 42, wherein said processor is further arranged, responsive to said instructions, to:
store said hub-originating shipment services data and said hub-destined shipment services data on said memory as a graph; and
for said data of each of said plurality of hubs, create a common node in said graph,
wherein said hub identification and said shipment service identification are responsive to said graph.

45. The server of claim 42, wherein said identification of said at least one hub whose catchment area containing said shipment origin comprises an identification of more than one of said plurality of hubs,
wherein said identification of said at least one hub whose catchment area contains said shipment destination comprises an identification of more than one of said plurality of hubs,
wherein said service destination of said identified hub-originating shipment service of a first of said hubs whose catchment area contains said shipment origin is a second of said hubs whose catchment area contains said shipment origin,
wherein said service destination of said identified hub-originating shipment service of said second of said hubs whose catchment area contains said shipment origin is a first of said hubs whose catchment area contains said shipment destination, and
wherein said service destination of said identified hub-destined shipment service of said first of said hubs whose catchment area contains said shipment destination is a second of said hubs whose catchment area contains said shipment destination.

46. The server of claim 42, wherein said memory further has stored thereon:
data regarding a plurality of shipment service sellers, each of said plurality of shipment service sellers associated with a respective one of said hub-originating shipments services and said hub-destined shipment services; and
data regarding a plurality of shipment service resellers, each associated with a one of said plurality of shipment service sellers, said datum of each shipment service reseller comprising a unique mark-up rule,
wherein said processor is further arranged, responsive to said instructions, to:
identify at least one of said plurality of shipment service resellers associated with said identified hub-originating shipment service and said identified hub-destined shipment service;
determine shipment route price information responsive to said determined shipment route and said unique mark-up rule of said identified at least one shipment service reseller; and
output to the user terminal, via said communications module, an indication of said determined shipment route price information.

47. A computer implemented cargo shipment route determination method, the method comprising:
determining a catchment area for each of a plurality of hubs;
receiving from a user terminal a shipment origin and shipment destination of the cargo;
determining, in real-time, at least one shipment route for the cargo from said received shipment origin to said received shipment destination responsive to said shipment origin, said shipment destination and said determined catchment area for one said plurality of hubs; and
outputting to the user terminal an indication of said determined at least one shipment route.

48. The method of claim 47, further comprising:
determining a plurality of geographical zones;
for each of said determined geographical zones, assigning a relevance ranking to each of said hubs within a predetermined distance of said geographical zone; and
associating a set of said determined geographical zones with each of said hubs responsive to said assigned relevance rankings and further responsive to a relevance ranking criterion, said catchment area of said hub determined responsive to said associated geographical zone set.

49. The method of claim 48, wherein said relevance ranking is assigned responsive to:
the distance between said geographical zone and said hub;
the shipment throughput of said hub; or
the operation frequency of hub-destined shipment services or hub-originating shipment services associated with said respective hub.

50. The method of claim 47, wherein said catchment area determining is performed prior to said receiving of the cargo shipment origin and destination.

51. The method of claim 47, further comprising:
receiving data regarding a plurality of sets of hub-originating shipment services, each hub-originating shipment service datum comprising a service origin and service destination pair, said service origins of each set of hub originating shipment services corresponding to a particular one of said plurality of hubs;
receiving data regarding a plurality of sets of hub-destined shipment services, each hub-destined shipment service datum comprising a service origin and service destination pair, said service destinations of each set of hub destined shipment services corresponding to a particular one of said plurality of hubs;
identifying one of said hubs responsive to said determined catchment area containing said shipment origin or said shipment destination; and
identifying a shipment service from said hub-originating shipment service set associated with said identified hub whose catchment area contains said shipment origin or from said hub-destined shipment service set associated with said identified hub whose catchment area contains said shipment destination,
wherein said shipment route determination is further responsive to said identified hub-originating shipment service or hub-destined shipment service.

52. The method of claim 47, further comprising:
receiving data regarding a plurality of sets of hub-originating shipment services, each hub-originating shipment service datum comprising a service origin and service destination pair, said service origins of each set of hub originating shipment services corresponding to a particular one of said plurality of hubs;
receiving data regarding a plurality of sets of hub-destined shipment services, each hub-destined shipment service datum comprising a service origin and service destination pair, said service destinations of each set of hub destined shipment services corresponding to a particular one of said plurality of hubs,
identifying at least one of said hubs responsive to said determined catchment area containing said shipment origin;
identifying at least one of said hubs responsive to said determined catchment area containing said shipment destination;
identifying a shipment service from said hub-originating shipment service set associated with said identified at least one hub whose catchment area contains said shipment origin; and
identifying a shipment service from said hub-destined shipment service set associated with said identified at least one hub whose catchment area contains said shipment destination,
wherein said shipment route determination is further responsive to said identified hub-originating shipment service an said identified hub-destined shipment service.

53. The method of claim 52, wherein said identified hub-originating shipment service and said identified hub-destined shipment service are the same.

54. The method of claim 52, further comprising:
storing said hub-originating shipment services data and said hub-destined shipment services data on a memory as a graph; and
for said data of each of said plurality of hubs, creating a common node in said graph,
wherein said hub identifying and said shipment service identifying are responsive to said graph.

55. The method of claim 52, wherein said identification of said at least one hub whose catchment area contains said shipment origin comprises an identification of more than one of said plurality of hubs,
wherein said identification of said at least one hub whose catchment area contains said shipment destination comprises an identification of more than one of said plurality of hubs,
wherein said service destination of said identified hub-originating shipment service of a first of said hubs whose catchment area contains said shipment origin is a second of said hubs whose catchment area contains said shipment origin,
wherein said service destination of said identified hub-originating shipment service of said second of said hubs whose catchment area contains said shipment origin is a first of said hubs whose catchment area contains said shipment destination, and
wherein said service destination of said identified hub-destined shipment service of said first of said hubs whose catchment area contains said shipment destination is a second of said hubs whose catchment area contains said shipment destination.

56. The method of claim 52, further comprising:
receiving data regarding a plurality of shipment service sellers, each of said plurality of shipment service sellers associated with a respective one of said hub-originating shipments services and said hub-destined shipment services;
receiving data regarding a plurality of shipment service resellers, each associated with a one of said plurality of shipment service sellers, said datum of each shipment service reseller comprising a unique mark-up rule;
identifying at least one of said plurality of shipment service resellers associated with said identified hub-originating shipment service and said identified hub-destined shipment service;
determining shipment route price information responsive to said determined shipment route and said unique mark-up rule of said identified at least one shipment service reseller; and
outputting to the user terminal, via said communications module, an indication of said determined shipment route price information.
